(19) United States
(12) Patent Application Publication
(10) Pub. No.: US 2023/0105910 A1
(43) Pub. Date: Apr. 6, 2023

(54) ENCODING INFORMATION WITH SHIFTED LINEAR PATTERNS

(71) Applicant: Hewlett-Packard Development Company, L.P., Spring, TX (US)

(72) Inventors: Matthew D. Gaubatz, Seattle, WA (US); Robert Ulichney, Stow, MA (US)

(73) Assignee: Hewlett-Packard Development Company, L.P., Spring, TX (US)

(21) Appl. No.: 17/792,662

(22) PCT Filed: Jan. 28, 2020
(86) PCT No.: PCT/US2020/015491

§ 371 Date: Jul. 13, 2022

(51) Int. Cl. G06K 19/06; G06K 1/12

(52) U.S. Cl. CPC G06K 19/06028; G06K 1/121

(57) ABSTRACT

An example non-transitory computer-readable medium includes instructions to generate a linear pattern of contrasting elements. The linear pattern encodes scannable information. The instructions are further to generate shifted instances of the linear pattern, a shifted instance being shifted with respect to the linear pattern along a length of the linear pattern. The instructions are further to form an array of the shifted instances of the linear pattern orthogonal to the length of the linear pattern to generate a two-dimensional pattern of the contrasting elements. The two-dimensional pattern repeatedly encodes the scannable information.

### BACKGROUND

Data-bearing images, such as barcodes, are widely used to allow computing devices to capture and share information. A barcode may be printed to a physical medium, such as paper, or displayed on a screen. Various techniques may be used to scan and decode barcodes, ranging from laser scanners using rotating prisms to smartphone cameras.

### BRIEF DESCRIPTION OF THE DRAWINGS

FIG. 1 is a schematic diagram of example instructions to generate a two-dimensional pattern of contrasting elements using shifted instances of a linear pattern to form a data-bearing image.

FIG. 2 is a schematic diagram of an example pattern of contrasting elements using shifted instances of a linear pattern formed from a repeated sub-pattern.

FIG. 3 is a schematic diagram of an example repeated sub-pattern.

FIG. 4 is a schematic diagram of an example grid to generate a pattern of contrasting elements using shifted instances of a linear pattern formed from a repeated sub-pattern.

FIG. 5 is a flowchart of an example method to generate a two-dimensional pattern of contrasting elements using shifted instances of a linear pattern to form a data-bearing image.

FIG. 6 is a flowchart of an example method to generate a two-dimensional pattern of contrasting elements using shifted instances of linear patterns to form a data-bearing image.

FIG. 7 is a schematic diagram of an example pattern of contrasting elements using shifted instances of linear patterns.

FIG. 8 is a flowchart of an example method to generate a two-dimensional pattern of contrasting elements with a selected degree of isotropy.

FIG. 9 is an example data-bearing image including a two-dimensional pattern of contrasting elements made from shifted instances of a linear pattern.

FIG. 10 is the example data-bearing image of FIG. 9 with reduced amplitude.

FIG. 11 is a block diagram of an example printing device, example scanner device, and example object carrying a data-bearing image formed of shifted instances of a linear pattern.

### DETAILED DESCRIPTION

Data-bearing images, such as barcodes (one-dimensional, two-dimensional, etc.), watermarks, and the like, may have an obtrusive appearance and/or may be difficult to properly scan and decode. Barcodes, for instance, may disturb the visual appearance of the carrying medium or object and further may require a scanner to be aimed at a relatively small specific location. While data-bearing images may be made aesthetically pleasing, this may mean reducing the detectability of the encoded information, where a reduced signal strength and reduces the likelihood of successful decoding. Often a tradeoff exists, in that obtrusive codes may readily scannable but visually disruptive, while visually pleasing codes may be prone to scanning difficulty or error. In addition, specialized scanning software/hardware may be needed for new types of data-bearing images.

Disclosed herein are techniques to generate readily decodable and visually unobtrusive patterns that embed data on a surface, such as a surface of a print medium or three-dimensional object. Such a pattern may be used to represent data while reducing or eliminating the visual disruption that may occur with barcode bars, two-dimensional barcodes, and the like. Example patterns may resemble a tone or texture and may appear unobtrusive to the viewer. Examples patterns may not unduly disturb the appearance of the carrier medium or object and may be readily scannable by off-the-shelf scanning software/hardware. Further, example patterns may be robust in that successful scanning and decoding may be possible despite the loss of a significant portion of the pattern.

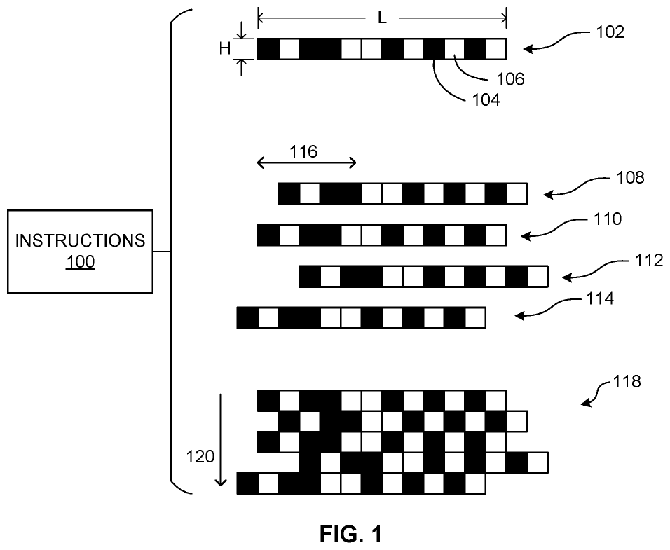

FIG. 1 shows example instructions 100 to generate a two-dimensional pattern of contrasting elements using shifted instances of a linear pattern to form a data-bearing image.

The instructions 100 may be executable by a processor, such as a central processing unit (CPU), a microcontroller, a microprocessor, a processing core, a field-programmable gate array (FPGA), an application-specific integrated circuit (ASIC), or a similar device capable of executing instructions. The instructions 100 may be stored in a non-transitory computer-readable medium that may be an electronic, magnetic, optical, or other physical storage device that encodes instructions. The non-transitory computer-readable medium may include, for example, random access memory (RAM), read-only memory (ROM), flash memory, a storage drive, an optical device, or similar.

The instructions 100 generate an original base instance of a linear pattern 102 of contrasting elements 104, 106. The linear pattern 102 may include a row, column, line, sequence, or other linear arrangement of contrasting elements 104, 106 that is defined by a principal length L. The linear pattern 102 may be contiguous (as illustrated) or disperse. That is, the contrasting elements 104, 106 may be directly adjacent, as shown, or may be spaced apart, as with a sequence of discrete dots.

The contrasting elements 104, 106 may include areas, dots, pixels, surface perturbations, or similar elements of contrasting color, intensity, reflectively, or other property of light. The example shown includes dark and light rectangles, where the outlines of the light rectangles are for illustrative purposes. Such dark and light rectangles may be displayed or printed as a row of pixels. In other examples, contrasting elements 104, 106 are localized areas of raised or lowered surface height on a three-dimensional object. For example, small recesses may be created in the surface of an object to form one type of contrasting element 104, while spaces between such recesses form another type of contrasting element 106. In various examples, a contrasting element 106 is the absence of a different type of contrasting element 104. That is, the light rectangles 106 may be formed by the negative space between the dark rectangles 104.

The linear pattern 102 of contrasting elements 104, 106 encodes scannable information. Scannable information is information that may be acquired by a scanner device, such as a barcode reader, smartphone camera, or similar device. The linear pattern 102 may be generated according to a one-dimensional barcode symbology. The linear pattern 102 may be considered to be a slice of a one-dimensional barcode, where such a slice is made perpendicular to the bars of the barcode.

Example one-dimensional barcode symbologies include those that are scannable and decodable by off-the-shelf systems, such as Universal Product Code (UPC), Code 39, International Article Number (EAN-13), to name a few.

The linear pattern 102 may have a length that is significantly larger than its height H. Example length-to-height ratios include 10:1, 20:1; 50:1, and 100:1.

The instructions 100 further generate shifted instances 108-114 of the linear pattern 102. A shifted instance 108-114 is shifted with respect to the linear pattern 102 along the length L of the linear pattern 102, i.e., in a direction of an axis 116 that is parallel to the direction of the progression of contrasting elements of the length L linear pattern, i.e., the axis in the direction of the length L of the linear pattern 102. Any number, direction, and degree of shifting of shifted instances 108-114 may be generated. Each shifted instance 108-114 may be shifted left or right a specific distance, which may be a whole/integer multiple of the unit size of the contrasting elements 104, 106. In the example shown, an instance 108 is shifted one element to the right compared to the original instance 102, an instance 110 is shifted one element to the left, an instance 112 is shifted two elements to the right, and an instance 114 is shifted two elements to the left.

The instructions 100 further form an array 118 of the shifted instances 108-114 of the linear pattern 102. The array 118 is formed along an axis 120 that may be orthogonal to the axis 116 in the direction of the length L of the linear pattern 102. As such, the array 118 inhabits a surface defined by the axis 116 of the length L linear pattern 102 and an orthogonal axis 120. If the shifted instances 108-114 are considered to be rows, then the shifted instances 108-114 may be considered to be stacked as a column of such rows. The original instance of the linear pattern 102 may be considered an instance that is shifted by zero distance and may be included in the array 118, as depicted.

Shifting may be performed according to a predefined relationship, such as a modulo function, a random or pseudo-random function, a blue noise function, or similar. Shifting may be circular, in that contrasting elements 104, 106 that would be shifted outside the intended finished dimensions of the array 118 at one side may be reinserted into the array at the opposite side.

The array 118 may form a two-dimensional pattern of contrasting elements 104, 106, such as an area of pixels, that repeatedly encodes the scannable information defined by the base linear pattern 102. The array 118 may be disposed on a surface, such as a planar or curved surface. The array 118 when situated on a curved surface may still be considered a two-dimensional pattern, in that information is encoded in the base linear pattern 102 in one dimension and shifted instances 108-114 of the base linear pattern 102 are arrayed in a different dimension, such as an orthogonal dimension.

When a scanner device is used to obtain the scannable information from the array 118, the scanner device may detect any of the shifted instances 108-114, or original instance, of the linear pattern 102. Hence, if the scanner device is misaligned with one of the instances 108-114, the scanner device may be aligned with another of the instances 108-114. A degraded, obscured, or occluded instance 108-114 may be compensated by repetition and redundancy provided by other instances 108-114. The scannable information can be extracted provided that a scanner device can successfully scan one of the instances 108-114.

In addition, any scanner device capable of scanning and decoding the one-dimensional barcode symbology used to generate the linear pattern 102 may be used to scan and decode the two-dimensional pattern. Further, such a scanner device does not require knowledge about the shifting methodology or degree of shift and can be used off-the-shelf.

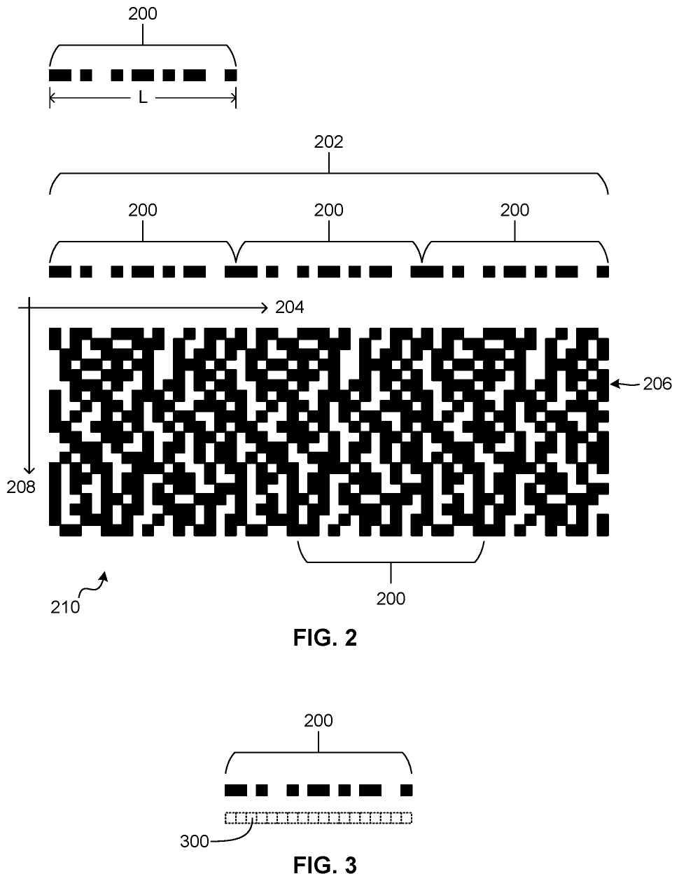

FIG. 2 shows an example generation of a two-dimensional pattern of contrasting elements using shifted instances of a linear pattern that is made of a repeated sub-pattern.

A sub-pattern 200 may be repeated along its length L to form a linear pattern 202. The linear pattern 202 may be shifted in a direction parallel to its axis 204 to obtain a shifted instance 206 of the linear pattern 202. Instances shifted by different amounts may be arrayed along an axis 208 perpendicular to the axis 204 of the linear pattern 202 to obtain an array 210. The array 210 contains a multitude of instances of the sub-pattern 200 offset in different directions in a surface defined by the axes 204, 208.

Each instance of the sub-pattern 200 encodes the same information and is independently scannable and decodable.

It should be noted that the axes 204, 208 may be straight and orthogonal and therefore may define a flat plane in which the array 210 is disposed. In other examples, one or both the axes 204, 208 may be curved, so that the array 210 is disposed in a surface having curvature. Regardless of the shape of the surface, the array 210 may be considered a two-dimensional pattern as it repeats scannable information in two distinct dimensions defined by the axes 204, 208.

It should be noted that the shifted repetition of the decodable sub-pattern 200 creates redundancy in the final array 210. As such, the sub-pattern 200 may still be detected and decoded despite significant loss of a portion of the array 210. Loss may be due to occlusion, shadow, ambient lighting conditions, damage to the surface of the object carrying the array 210, and so on. When the array 210 is applied to an object, a portion of the array 210 may not be scannable due to the shape of the object.

As shown in FIG. 3, a sub-pattern 200 may be considered to have N possible regions 300 (or pixels) of contrasting elements. The example sub-pattern 200 shown has N=18 possible regions 300, where contrasting elements are either single dark/light regions or double dark/light regions. A linear pattern 202 made of the sub-pattern 200 may thus be considered to have a period of N and may be shifted in one direction by up to N−1 regions 300 in distance to obtain a uniquely shifted linear pattern.

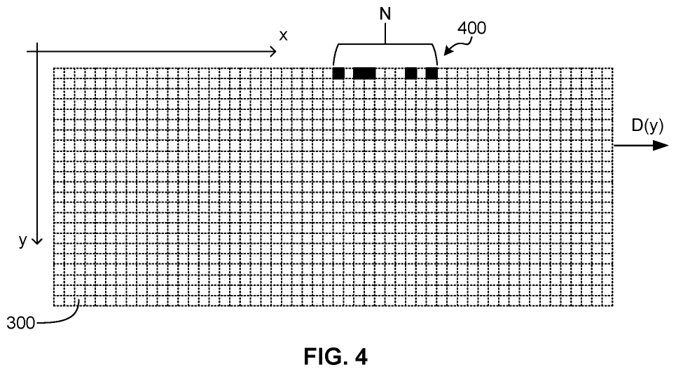

With reference to FIG. 4, a sub-pattern 400 that has a period N and that extends along an x axis may be repeated in the x direction any number of times to form a linear pattern. Any number of shifted instances of the linear pattern may be arrayed along a y axis, which may be orthogonal to the x axis, to populate a grid with instances of the sub-pattern 400.

A shifting function D(y) may be used to define the shifted instances of a linear pattern 400 as a function of a perpendicular row position in an array 300.

In some examples, random or pseudo-random shifts are used, such that:

D(y)=round(R_{y}(N−2))+1

where R_{y} is a uniformly distributed random number between 0 and 1 determined for each instance in the y direction, and where “round” is a function that rounds to the nearest integer.

In other examples, modulo-based shifts are used, such that:

D(y)=C y mod(N−1)+1

where C is a constant between 1 and N−1 and “mod” is a modulo operator. In this example, each row of offset from the row above by the same amount.

In other examples, a deterministic and periodic set of numbers can be used to specify the row-to-row shifts. The period could be short or as long as the entire output pattern. The set of numbers could be chosen by a wide variety of criteria. One such criteria could be the visual homogeneity of the resulting pattern optimized specifically for each barcode payload. A variety of two-dimensional metrics could be used for this purpose to quantify the pattern homogeneity for each candidate sequence of numbers to find the optimum.

Examples of suitable shifting functions include non-zero functions that provide different shifts among different rows of instances of the linear pattern. While shifts may be repeated, repeating a shift for adjacent rows may be avoided. The shifting function need not be known to the scanner/decoder device.

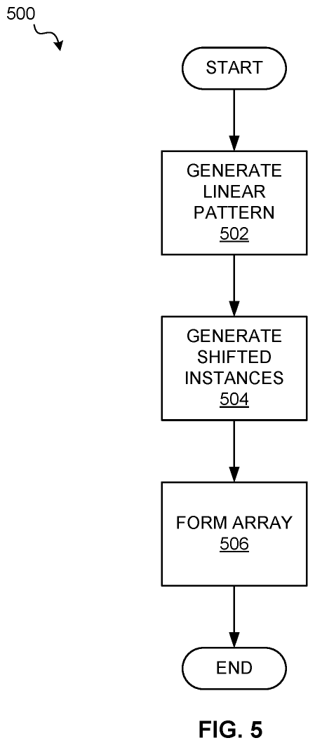

FIG. 5 shows an example method 500 to generate a two-dimensional pattern of contrasting elements using shifted instances of a linear pattern to form a data-bearing image. The method 500 may be implemented by a set of instructions (e.g., instructions 100 of FIG. 1) that may be stored in a non-transitory computer-readable medium and executed by a processor.

At block 502, a linear pattern of contrasting elements is generated. The linear pattern encodes scannable information that may be selected as scannable and decodable using off-the-shelf equipment. For example, the linear pattern may be generated using a one-dimensional barcode symbology, such as UPC, Code 39, EAN-13, or similar. A linear pattern may be made of a repeated sub-pattern. For example, a sequence of dark/light areas generated according to UPC may be repeated a number of times.

At block 504, shifted instances of the linear pattern are generated. A shifted instance is shifted with respect to the original linear pattern along a length of the linear pattern. A shifting function may be applied to provide different shifts among different rows and the same shift for adjacent rows may be avoided.

At block 506, an array of the shifted instances of the linear pattern is formed orthogonal to the axis in the direction of the length of the linear pattern. The resulting two-dimensional pattern of the contrasting elements may be outputted, such as by being displayed on a display device, printed to a print medium, or 3D printed to the surface of an object. The two-dimensional pattern repeatedly encodes the scannable information. The two-dimensional pattern is scannable and decodable by a system that implements the one-dimensional barcode symbology used to define the linear pattern.

It should be noted that blocks of the method 500 may be performed in an order different from that described. Functionality of a block may be separated into a new block or combined with functionality of another block. For example, the array may be constructed as each shifted instance is generated or the array may be constructed after all shifted instances are generated.

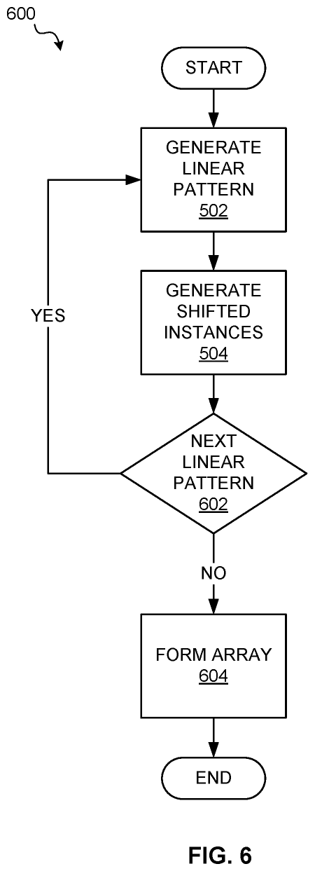

FIG. 6 shows an example method 600 to generate a two-dimensional pattern of contrasting elements using shifted instances of multiple linear patterns to form a data-bearing image. The method 600 may be implemented by a set of instructions (e.g., instructions 100 of FIG. 1) that may be stored in a non-transitory computer-readable medium and executed by a processor. The method 500 may be referenced for details not repeated here, with like reference numerals denoting like blocks.

As controlled by block 602, multiple different linear patterns and shifted instances thereof are generated at blocks 502, 504.

A first linear pattern may encode first scannable information and a second linear pattern may encode second scannable information that is different from the first scannable information. That is, multiple different pieces of information may be encoded by different linear patterns. Any suitable number of linear patterns and symbologies may be used.

Shifted instances of each linear pattern are generated. The degree and type of shifting may be computed by a shifting function. The same shifting function may be used for multiple different linear patterns. In other examples, shifting may be performed differently for different linear pattern used. That is, a second shifting function may be used for the second linear pattern, where the second shifting function differs from a first shifting function used for the first linear pattern.

At block 604, an array is formed from the shifted instances of the different linear patterns to generate a two-dimensional pattern that repeatedly encodes the scannable information defined by each different linear pattern. An arraying function may be used to form the array. For example, shifted instances of different linear patterns may be interlaced. A shifted instance of a second pattern may follow a shifted instance of a first pattern, then a different shifted instance of the first pattern may follow, as so on. Another example of an arraying function is a random function that randomly shuffles the shifted instances of the multiple linear patterns.

It should be noted that blocks of the method 600 may be performed in an order different from that described. Functionality of a block may be separated into a new block or combined with functionality of another block. For example, the different linear patterns may be generated before any shifted instances are generated.

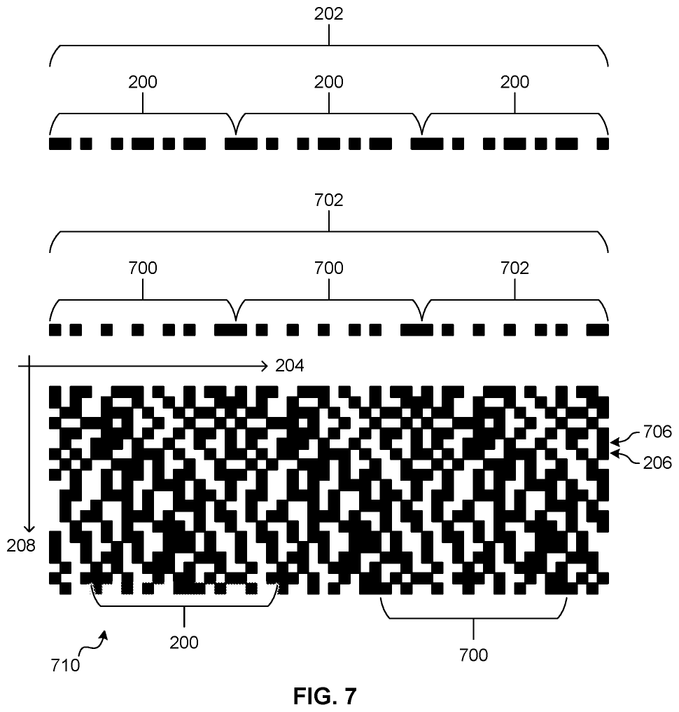

FIG. 7 shows an example generation of a two-dimensional pattern of contrasting elements using shifted instances of different linear patterns made of different repeated sub-patterns.

A first linear sub-pattern 200 may be repeated in the direction of its length to form a first linear pattern 202. Similarly, second linear sub-pattern 700 may be repeated in the direction of its length to form a second linear pattern 702. The first and second linear sub-patterns 200, 700 may encode different information. The first and second linear sub-patterns 200, 700 may be generated using the same one-dimensional barcode symbology or different one-dimensional barcode symbologies. For example, the first linear sub-pattern 200 may comply with a UPC encoding and the second linear sub-pattern 700 may follow an EAN encoding.

The first linear pattern 202 may be shifted in a direction parallel to its principal axis 204 to obtain shifted instances 206 of the first linear pattern 202. Similarly, the second linear pattern 702 may be shifted in the same direction or an opposite direction to obtain shifted instances 706 of the second linear pattern 202. Any number and degree of shifting may be used to generate shifted instances of the different linear patterns 202, 702.

The shifted instances may be arrayed in a direction along an axis 208 orthogonal to the linear pattern axis 204 to obtain a two-dimensional array 710 that encodes the information defined by the different sub-patterns 200, 700. The array 210 contains a multitude of instances of the sub-patterns 200, 700. When scanned/decoded by a device that understands the one-dimensional barcode symbology used, sub-patterns 200, 700 may be successfully decoded. If different symbologies are used and the device is capable of both, then sub-patterns 200, 700 may be successfully decoded. If the device not capable of all symbologies used, then fewer sub-patterns 200, 700 may be successfully decoded.

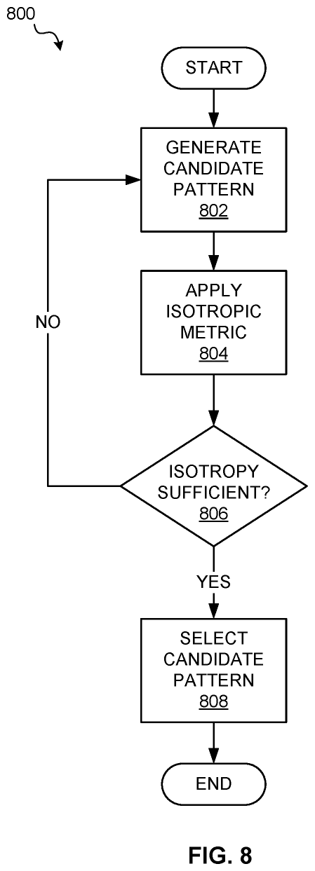

FIG. 8 shows an example method 800 to generate a two-dimensional pattern of contrasting elements with a selected degree of isotropy. The method 800 may be implemented by a set of instructions (e.g., instructions 100 of FIG. 1) that may be stored in a non-transitory computer-readable medium and executed by a processor.

At block 802, a candidate two-dimensional pattern is generated based on a linear pattern of contrasting elements, as discussed elsewhere herein, such as by methods 500, 600. While a base sub-pattern of the two-dimensional pattern may be immutable due to the information being encoded, a shifting function may provide a varying degree of isotropy to the two-dimensional pattern. The shifting function or a parameter thereof, may be varied to obtain candidate two-dimensional pattern with varying degrees of isotropy.

At block 804, an isotropic metric is applied to the candidate two-dimensional pattern to obtain an indication of isotropy. Example isotropic metrics include halftone quality metrics, blue noise metrics, a smoothness metric, and similar.

An example smoothness metric considers a standard deviation based on graininess, mottle, and structure in a candidate two-dimensional pattern to evaluate an overall smoothness of the pattern. Graininess may include period-fluctuations (noise) of image density at a relatively high spatial frequency. Mottle may include aperiodic fluctuations of image density at a relatively low spatial frequency. Structure may include structured/periodic noise, such as one-dimensional features at any orientation, two-dimensional defects, high frequency defects, and similar. The standard deviation may be proportional to a root sum of squares of the graininess, mottle, and structure.

A plurality of candidate two-dimensional patterns may be generated using different linear patterns of contrasting elements. The isotropy of each candidate may be tested, at block 806, to select a candidate two-dimensional patterns for use, at block 808. A pattern with isotropy may appear less obtrusive to observers and may therefore have less effect on the appearance of the object or medium carrying the pattern. As such, a pattern with high isotropy may be selected for use when disturbance to the appearance of the carrier is to be reduced or avoided. In addition, a sufficient isotropy need not be particularly high. It may be sufficient that a pattern avoids distracting structure.

In some examples, candidate two-dimensional patterns are generated and tested, one after the other, until a target isotropy is achieved. Isotropic variance in the candidate two-dimensional patterns may be achieved by selecting the shifting function or a parameter thereof, such as a seed for a pseudo-random number generator. A threshold minimum acceptable isotropy may be used. A candidate two-dimensional pattern may be tested against the threshold and then selected or discarded, in which case another candidate two-dimensional pattern may be generated and tested. In other examples, a batch of candidate two-dimensional patterns of varying isotropy are generated and tested. Then, the pattern with the greatest isotropy may be selected.

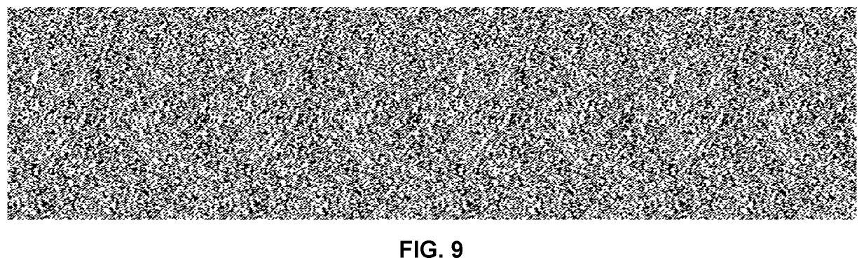

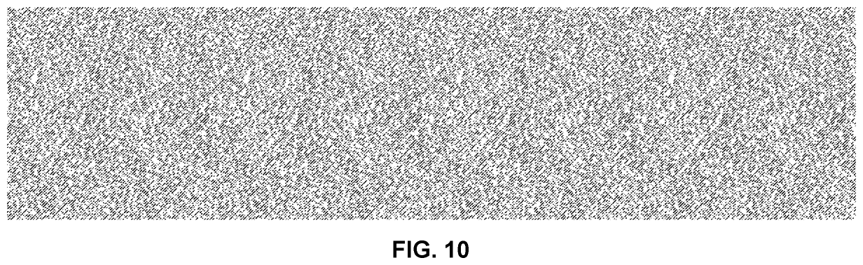

FIG. 9 shows an example data-bearing image including a two-dimensional pattern of contrasting elements made from shifted instances of a linear pattern using the techniques discussed herein. The visual obtrusiveness may be reduced by reducing the amplitude of the image, as shown in FIG. 10. For example, the image may be made less visually apparent by reducing the intensity or black level of the dark areas.

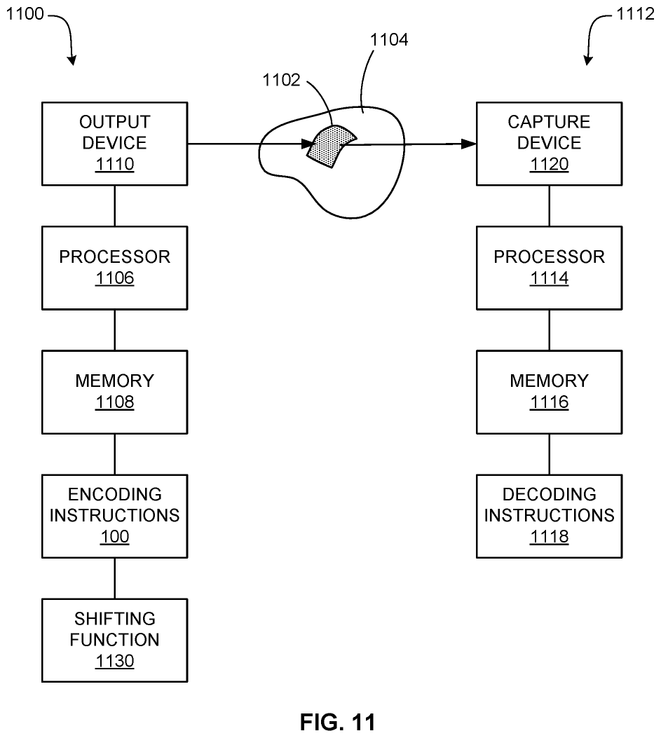

With reference to FIG. 11, an example printing device 1100 may include encoding instructions 100 to generate a data-bearing image 1102, as discussed herein, and provide such image 1102 to a three-dimensional object 1104. The instructions 100 generate a one-dimensional linear pattern as well as shifted instances of such pattern made according to a shifting function 1130.

The printing device 1100 may include a processor 1106 to execute the instructions 100 and a memory 1108 connected to the processor 1106 to store the instructions 100. The printing device 1100 may further include an output device 1110, such as a print engine, display device, or 3D printing apparatus. For example, the output device 1110 may include a printhead to output heat and/or a chemical agent that solidifies powdered material in a print bed to progressively form layers of a 3D object 1104. The instructions 100 may embed a data-bearing image 1102 in the surface geometry of the object 1104, such as by way of flats and recesses, peaks and valleys, or texture.

Also shown in FIG. 11 is a scanner device 1112 to scan the data-bearing image 1102 on the 3D object 1104. The scanner device 1112 may include a processor 1114 and connected memory 1116 to execute decoding instructions 1118 to decode a scanned image. The scanner device 1112 may further include a capture device 1120 to capture the data-bearing image 1102. Example capture devices include laser devices and cameras. It should be noted that in many examples the decoding instructions 1118 do not have access to the shifting function 1130. That is, the scanner device 1112 may capture and decode the data-bearing image 1102 with no knowledge of the shifting function 1130 used to generate the data-bearing image 1102.

It should be apparent from the above that a visually unobtrusive data-bearing image may be scanned and decoded using existing software/hardware. The scanning and decoding system does not require knowledge of a shifting methodology used to create a two-dimensional pattern from a one-dimensional pattern. Error-control inherent in one-dimensional barcode techniques may allow a single instance of a linear pattern to be decodable without referencing another part of the data-bearing image. A decoupling of repetition and verifiability makes it possible for a single contiguous instance of a linear pattern to be usable. The techniques described herein may thus be useful for tagging of objects in that local deformations may create unpredictable errors in rendering, but that in a given area it is likely that several instances of a linear pattern will be rendered with reasonable fidelity. A representation of data may be applied across a potentially large amount of space and can be locally interpreted and verified, without more than a single instance of the underlying message.

It should be recognized that features and aspects of the various examples provided above can be combined into further examples that also fall within the scope of the present disclosure. In addition, the figures are not to scale and may have size and shape exaggerated for illustrative purposes.

1. A non-transitory computer-readable medium comprising instructions to:
generate a linear pattern of contrasting elements, wherein the linear pattern encodes scannable information;
generate shifted instances of the linear pattern, wherein a shifted instance is shifted with respect to the linear pattern along a length of the linear pattern; and
form an array of the shifted instances of the linear pattern orthogonal to the length of the linear pattern to generate a two-dimensional pattern of the contrasting elements, wherein the two-dimensional pattern repeatedly encodes the scannable information.

2. The non-transitory computer-readable medium of claim 1, wherein the instructions are further to:
generate a plurality of candidate two-dimensional patterns based on different linear patterns of contrasting elements;
apply an isotropic metric to each candidate two-dimensional pattern of the plurality of candidate two-dimensional patterns to obtain a respective indication of isotropy; and
select the two-dimensional pattern as the candidate two-dimensional pattern based on the indication of isotropy.

3. The non-transitory computer-readable medium of claim 1, wherein the linear pattern represents a row of pixels and wherein the two-dimensional pattern represents an area of pixels.

4. The non-transitory computer-readable medium of claim 1, wherein the instructions are further to generate the linear pattern of contrasting elements according to a one-dimensional barcode symbology.

5. The non-transitory computer-readable medium of claim 1, wherein the linear pattern comprises a repeated sub-pattern.

6. The non-transitory computer-readable medium of claim 1, wherein the instructions are further to:
generate a second linear pattern of contrasting elements, wherein the second linear pattern encodes second scannable information;
generate second shifted instances of the second linear pattern, wherein a second shifted instance is shifted with respect to the second linear pattern along a length of the second linear pattern; and
form the array from the second shifted instances of the second linear pattern and the shifted instances of the linear pattern to generate a two-dimensional pattern that repeatedly encodes the second scannable information and the scannable information.

7. The non-transitory computer-readable medium of claim 1, wherein the instructions are further to print the two-dimensional pattern to a surface of a three-dimensional object.

8. A device comprising:
an output device;
a processor to:
generate a linear pattern that encodes information according to a one-dimensional barcode symbology;
generate an array with shifted instances of the linear pattern, wherein a shifted instance is shifted with respect to the linear pattern along an axis of a length of the linear pattern, wherein the array repeatedly encodes the information; and
output a representation of the array at the output device.

9. The device of claim 8, wherein the processor is to apply a shifting function to the linear pattern to obtain shifted instances of the linear pattern.

10. The device of claim 9, wherein the shifting function comprises a random or pseudo-random function.

11. The device of claim 8, wherein the processor is further to apply an isotropic metric to the array.

12. The device of claim 8, wherein the processor is further to generate a plurality of arrays with different shifted instances of the linear pattern and select the array from the plurality of arrays based on isotropy of the array.

13. The device of claim 8, wherein the linear pattern comprises a sub-pattern repeated in a direction of the axis of the length of the linear pattern.

14. A method comprising:
generating a linear pattern of contrasting elements to encode information;
generating shifted instances of the linear pattern by shifting the linear pattern along a length of the linear pattern; and
forming a two-dimensional pattern of the contrasting elements by arranging the shifted instances orthogonally with respect to an axis in a direction of the length of the linear pattern, wherein the two-dimensional pattern repeatedly encodes the information.

15. The method of claim 14, wherein generating the shifted instances of the linear pattern includes cyclically shifting the linear pattern.
